(19) United States
(12) Patent Application Publication
(10) Pub. No.: US 2015/0230437 A1
(43) Pub. Date: Aug. 20, 2015

(54) System and Method of a Dormant Bio-Cycling Rock

(71) Applicant: CaribSea, Inc., Ft. Pierce, FL (US)

(72) Inventor: Richard M. Greenfield, JR., Ft. Pierce, FL (US)

(21) Appl. No.: 14/621,492

(22) Filed: Feb. 13, 2015

Related U.S. Application Data
(60) Provisional application No. 61/940,115, filed on Feb. 14, 2014.

(51) Int. Cl. A01K 63/04; A01K 63/00

(52) U.S. Cl. CPC A01K 63/04; A01K 63/006

(57) ABSTRACT

A dry, visually life-like rock containing dormant bacteria for use in aquariums is disclosed. A dry, visually life-like rock containing dormant bacteria can be packed in traditional packaging and shipped by the most economical means in the most economical packaging. Once it has arrived, it may be stored dry and in its original container. This rock can then be used when desired.

In accordance with 37 C.F.R. 1.76, a claim of priority is included in an Application Data Sheet filed concurrently herewith. Accordingly, the present invention claims priority to U.S. Provisional Patent Application No. 61/940,115, entitled “A DRY, VISUALLY LIFELIKE ROCK CONTAINING DORMANT BACTERIA FOR USE IN AQUARIUMS”, filed Feb. 14, 2014. The contents of the above referenced application is incorporated herein by reference.

### FIELD OF THE INVENTION

This invention relates generally to the field of biochemical cycling in a aquatic environment, and in particular a visually life-like porous rock containing dormant bacteria that become active when introduced to an aquatic environment, such as an aquarium, to promote biochemical cycling to balance nitrogen levels with the aquatic environment.

### BACKGROUND OF THE INVENTION

Aquariums have been popular for many years for both novice and expert aquarists alike. The typical aquarium contains a diverse mix of marine life, including aquatic plants, fish, and invertebrates. As the popularity of both marine and freshwater aquariums continues to grow, the number of retail products designed to assist the aquarist establish and maintain a healthy aquatic habitat also increases.

Unlike the essentially open systems of oceans and lakes, fish excrement and decaying food inside the closed system of an aquarium can quickly accumulate, especially in new aquariums. The accumulation of organic material increases the levels of toxic nitrogenous compounds, such as ammonia and nitrite, beyond that which can be tolerated by the inhabitants, creates a stressful or even fatal environment for the marine life.

This problem is commonly known as “new tank syndrome,” and frequently occurs with users that are new to maintaining aquatic environments. The greatest danger posed is during the first couple months of starting an aquarium.

To maintain a healthy environment the level of these harmful compounds must remain low. This often requires frequently changing the water inside of the aquarium, and the use of complex and/or mechanical filtration systems. Chemical filtration systems include, for example, activated carbon to remove dissolved organic compounds. Mechanical filtration systems assist in the collection of the solid wastes and excess food. However, neither mechanical nor chemical filtration techniques are particularly effective in removing toxic nitrogenous compounds like ammonia and nitrite.

While ammonia and nitrite are toxic to fish at very low levels (several parts-per-million (ppm)), the fish are able to tolerate several hundred ppm of nitrate. Fortunately, beneficial microorganisms (nitrifiers) are able to convert harmful ammonia into tolerable nitrates through a process called nitrification. Examples of some beneficial microorganisms which drive this nitrification process include aerobic bacteria Nitrosomonas and Nitrobacter. First, Nitrosomonas oxidize the ammonia to nitrite ions and water. The nitrite-rich metabolic waste of these microorganisms is then available as a food source for Nitrobacter, which oxidize the nitrite ions to nitrate. Aquatic plants and algae utilize nitrate as a fertilizer and during plant respiration, thereby keeping nitrate levels at an acceptable level in the water. Nitrosomonas and Nitrobacter are part of the family of Nitrobacteraceae. Five genera are generally accepted as ammonia-oxidizers and four genera as nitrite-oxidizers. Different genera exhibit different qualities, and for the present invention, bacteria exhibiting qualities of dormancy in a spored state or capable of remaining dormant when dried out are preferred.

The nitrification process can also be accomplished with heterotrophic nitrifying bacteria. Heterotrophic bacteria can reproduce at far faster rates than autotrophic bacteria. Some species of heterotrophic bacteria can oxidize or reduce nitrogenous compounds directly to nitrites, nitrate, or other forms of nitrogen.

The aforementioned nitrification processes are but a portion of a larger biochemical cycle. Biochemical cycling is the process of establishing equilibrium between the synthesis of ammonia as a result of waste production and decay of organic constituents, and its ultimate conversion into nitrate by the beneficial microorganisms in situ.

However, establishing conditions for biochemical equilibrium within a pristine aquarium may take upwards of six weeks depending on the aquarium type (freshwater or marine), and conditions (pH, temperature, bioload, light conditions, etc). This slow initial cycling period is due to the slow rate at which the microorganisms reproduce and establish a biofilm (the matrix created by the microorganisms on a substrate in which they reside). It is during this initial cycling period that the aquarium inhabitants are most vulnerable.

When fish or other animals are added to an aquarium, a small number of these beneficial microorganisms are often attached and begin colonizing the aquarium. However, the number of animals introduced often overwhelms the nascent colonies of microorganisms and the ammonia level quickly rises to a toxic level. Accordingly, commercial products have been developed that attempt to quickly establish biochemical cycling (equilibrium) in the closed system by introducing cultures of these beneficial nitrifying microorganisms into the aquarium.

One such product is a porous underwater rock containing these living microorganisms (either cultured or wild collected), known as “live rocks” in the aquatic pet trade. “Live rocks” are desirable for introducing these beneficially nitrifying microorganisms into the aquatic environment. Additionally, “live rocks” are used for their aesthetic beauty, adding the appearance of a natural aquatic environment to a fish tank. Generally, these “live rocks” are harvested from an underwater source, and must be shipped and stored remaining wet or underwater to preserve the mortality of the nitrifying microorganisms. This significantly increases the expense and inconvenience of purchasing a “live rock.”

At present, “live rocks” are expensive to pack, must be rushed to market by costly means (often by airfreight), are prone to leakage. Once in a retail setting, they must be stored in aquariums until sold to preserve the microorganisms in a wet environment. This takes up limited aquarium display space and requires expenditures on electricity.

U.S. Pat. No. 3,963,576 discloses a method for rendering bacteria dormant. The method includes growing bacteria under aerobic conditions in a aqueous media to produce at least one species of bacteria capable of enzymatically reducing nitrate to nitrogen and one species of bacteria capable of photosynthetically forming red pigment; dissolving an effective amount of at least one compound selected from the group consisting of sulfides of sodium and potassium in the bacteria containing media; and exposing the sulfide containing media under aerobic conditions to light for a period of time sufficient to cause red photosynthetic pigment to develop in the bacteria. This process producing a suspension of dormant bacteria.

U.S. Pat. No. 5,314,542 discloses a culture of Nitrosomonas packaged in a manner to induce a metabolic state of dormancy under conditions favorable for survival of up to at least one year at room temperature, and a method for its rapid reactivation to complete metabolic activity within about 72 hours of its addition into an aquarium. The bacteria then oxidizing and preventing harmful ammonia accumulation in the aquarium.

U.S. Pat. No. 6,376,229 discloses a method of harvesting and packaging marine substrate material with an optimal amount of water and air in retail packaging specifically dimensioned and configured for maintaining ammonia oxidizing bacteria in a state wherein the bacteria are capable of metabolic and physiologic activity after prolonged periods at room temperature. In the first aspect, a method is disclosed for harvesting materials that are naturally rich with bacteria, such as sand, shells, aragonite, and crushed coral materials. These are harvested from submerged marine environments, and packaged in specifically sized sealed containers, suitable for storage at room temperature and retail sale, such that the marine bacteria are preserved in their natural habitat in biofilms attached to the granular surfaces for extended periods of time. In a second aspect, there is disclosed an enrichment solution for further extending the period of time that the microorganisms remain bio-actively viable.

Therefore, the present invention satisfies a long-felt need by providing a bio-cycling aquatic rock that is also visually life-like that can be more readily manufactured, can be transported, displayed, and sold while dry and at room temperature, but will become bio-active after introduction to an aquatic environment. Thus eliminating the problems that the prior art attempted to mitigate.

What is lacking in the prior art is a dry, visually life-like rock containing dormant bacteria that can be packed in traditional packaging and shipped by the most economical means in the most economical packaging. Once the life-like rock arrives at a store, it may be stored dry and in its original container. This type of rock can then be used when desired by introduction into an aquatic environment.

### SUMMARY OF THE INVENTION

The present invention provides a dormant bio-active rock that achieves the natural living appearance of, and water purifying function of, a “live rock” in a more convenient and economical form. Because the bio-active rock is dormant when dry it can be packed, shipped, and stored economically as dry goods rather than livestock. This provides significant gains in economy for retailers and mail order houses. The life-like appearance gives the visual appeal of a rock that once resided in the ocean with a coating of colorful living organisms. The bacterial inoculation is necessary to function in the same water purifying capacity as a “live rock” when ultimately placed into an aquarium. To be able to pack, ship, and store as a dry good rather than livestock, the bacterial inoculation must first dry.

The present invention differs from what currently exists. Prior to this invention, “live rocks” were either collected underwater from tropical oceans or terrestrial rocks were seeded in the ocean to grow bacteria and a visually appealing coating of living marine life. Recently, man-made rocks have been cultured in captivity for this same purpose. All these rocks are then harvested and transported to retailers in bags of water or swaddled in wet paper and placed in boxes with a plastic liner. The “live rocks” are then rushed to market before incurring a significant die off of the bacterial content.

Boxes often leak while traveling and are discarded or are delayed at airports causing the rock's living components to die. Extreme cold or hot temperatures will incur mortality as well. This makes shipping in winter or the hottest months of the year risky. The mortality of rocks living inhabitants creates noxious odors and negatively affects the visual qualities of the rock.

By contrast, the present invention may be shipped and stored by normal and economical means, and will not be negatively affected, either visually or biologically, by mishandling. The present invention provides a unique structure for activation of a biochemical cycling process within an aquatic environment; one that can be stored dry at room temperature until it is ready to be used. The structure is coated with a substrate containing dormant microorganisms which become active when introduced to an aquatic environment containing ammonia and nitrite. The dormant bio-cycling rocks of the present invention are sold dry but still have a visually life-like appearance. They can be shipped and stored as regular goods rather than aquatic livestock resulting in significant savings and convenience.

Accordingly, it is a primary objective of the instant invention to provide a “live rock” substitute in the form of a visually life-like porous rock containing dormant bacteria which become active upon immersion into the water of an aquarium.

It is a further objective of the instant invention to provide a visually life-like rock which can be shipped, stored, and sold dry, avoiding the problems associated with live rocks harvested from underwater.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

The patent or application contains at least one drawing executed in color. Copies of this patent or patent application publication with color drawings will be provided by the Office upon request and payment of the necessary fee.

FIG. 1 is a pictorial view a suitable porous base rock;

FIG. 2 is a pictorial view of the base rock having been colored with a natural background color;

FIG. 3 is a pictorial view of the base rock with a first color coating;

FIG. 4 is a pictorial view of the base rock with a first and second color coating;

FIG. 5 is a pictorial view of the colored base rock being dipped into the substrate of dormant microorganisms;

FIG. 6 is a pictorial view of the dry, visually life-like rock;

FIG. 7 is a pictorial view of the once dormant bio-active rock in an aquatic environment where the bacteria have become active;

FIG. 8 is a pictorial view of an alternate base rock;

FIG. 9 is a pictorial view of the alternate base rock colored with a natural background color;

FIG. 10 is a pictorial view of the alternate base rock after removal from the dormant bacterial substrate;

FIG. 11 is a pictorial view of the alternate base rock coated with dormant bacterial substrate; and

FIG. 12 is a pictorial view of the dormant bio-cycling rock in an aquatic environment.

### DETAILED DESCRIPTION OF THE INVENTION

The dormant bio-active rock of the present invention can be packed in traditional packaging and shipped by the most economical means in the most economical packaging. Once it has arrived, it may be stored dry and in its original container. This rock can then be used when desired by placing the dormant bio-active rock into an aquatic environment, where the bio-cycling organisms change from their dormant state and begin the bio-cycling process.

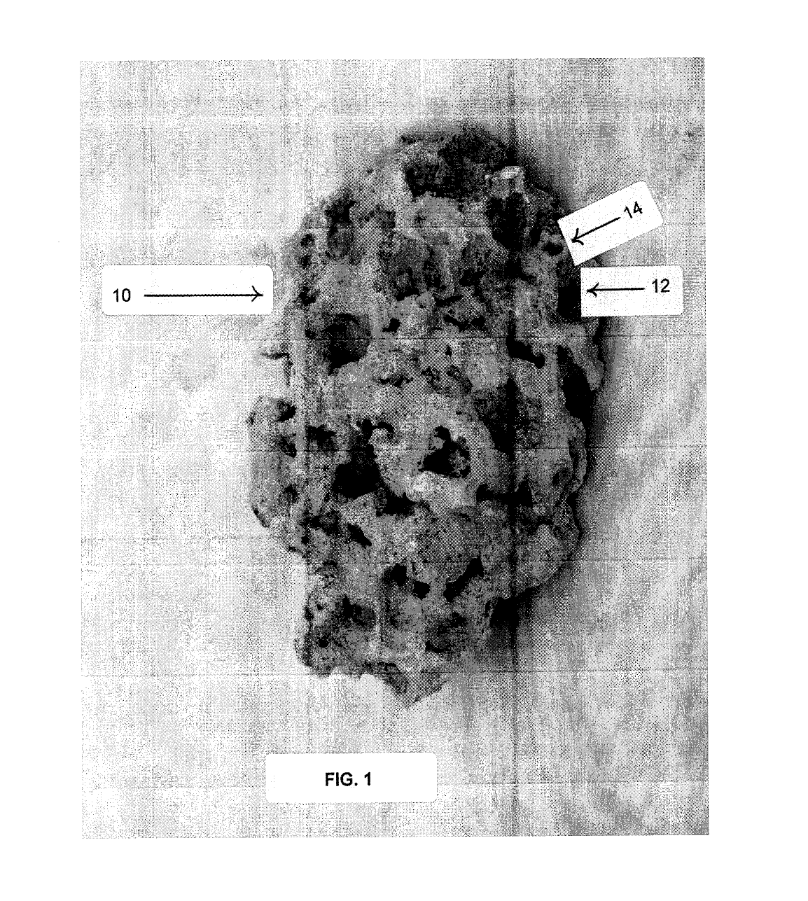

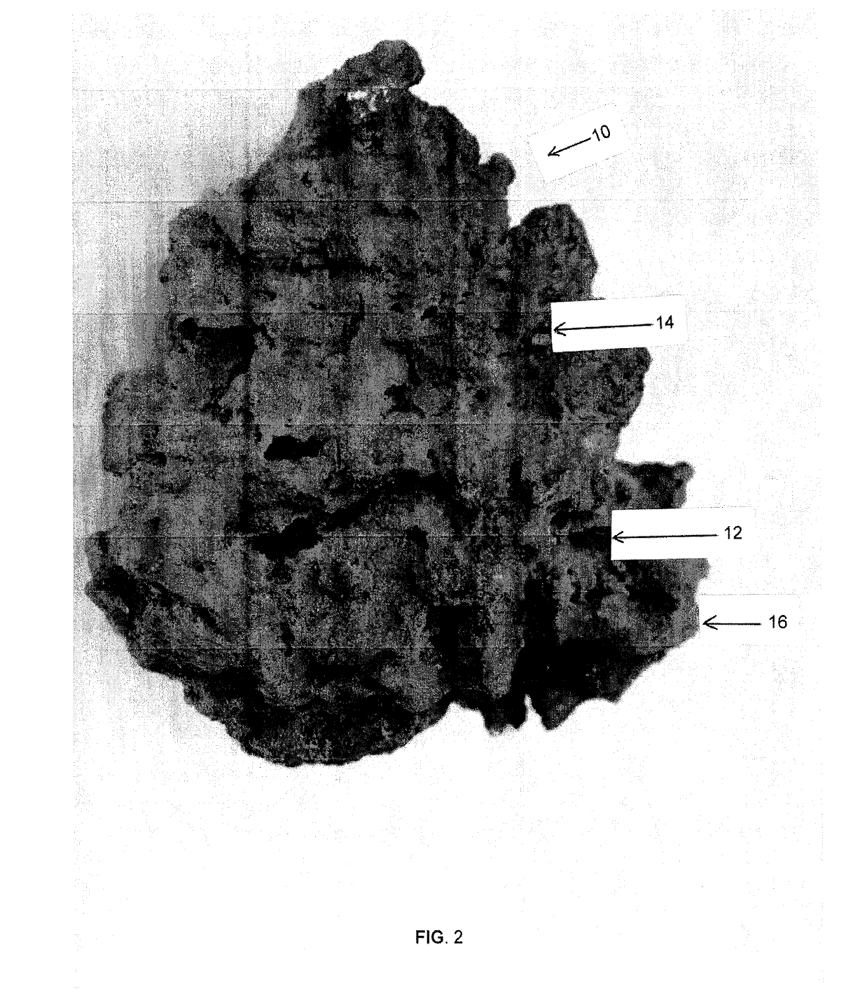

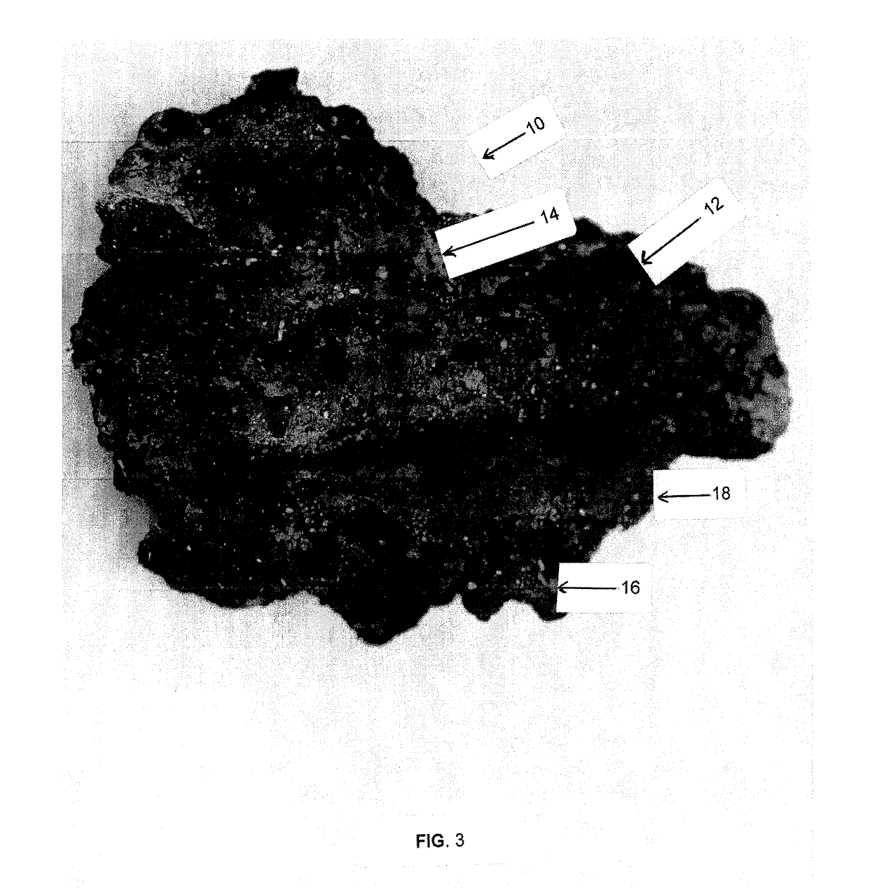

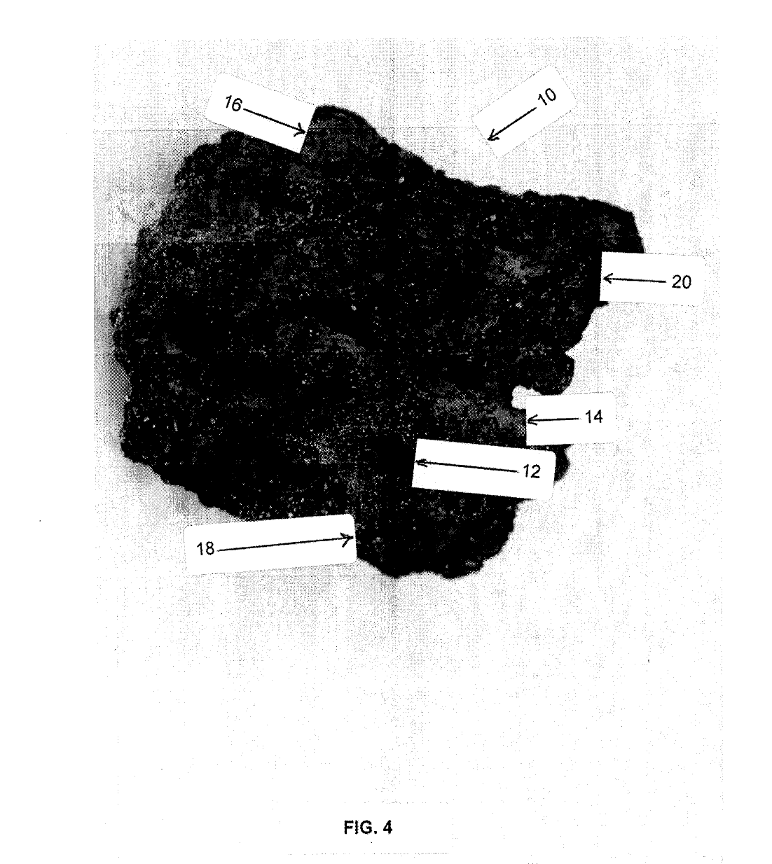

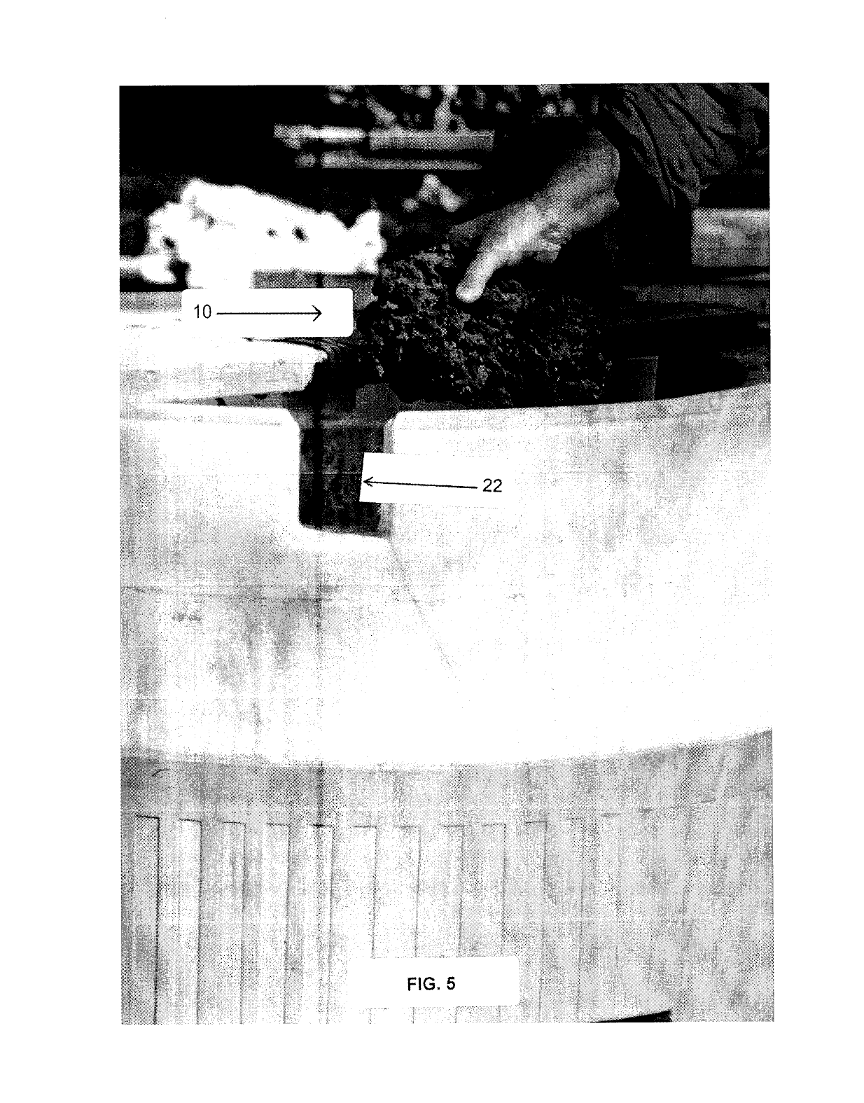

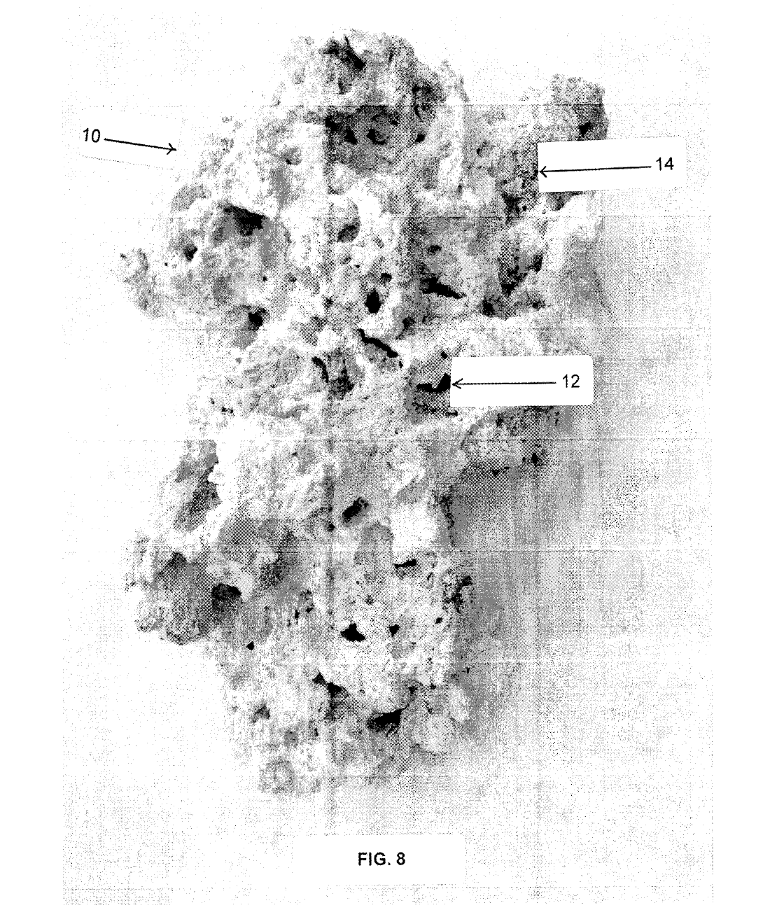

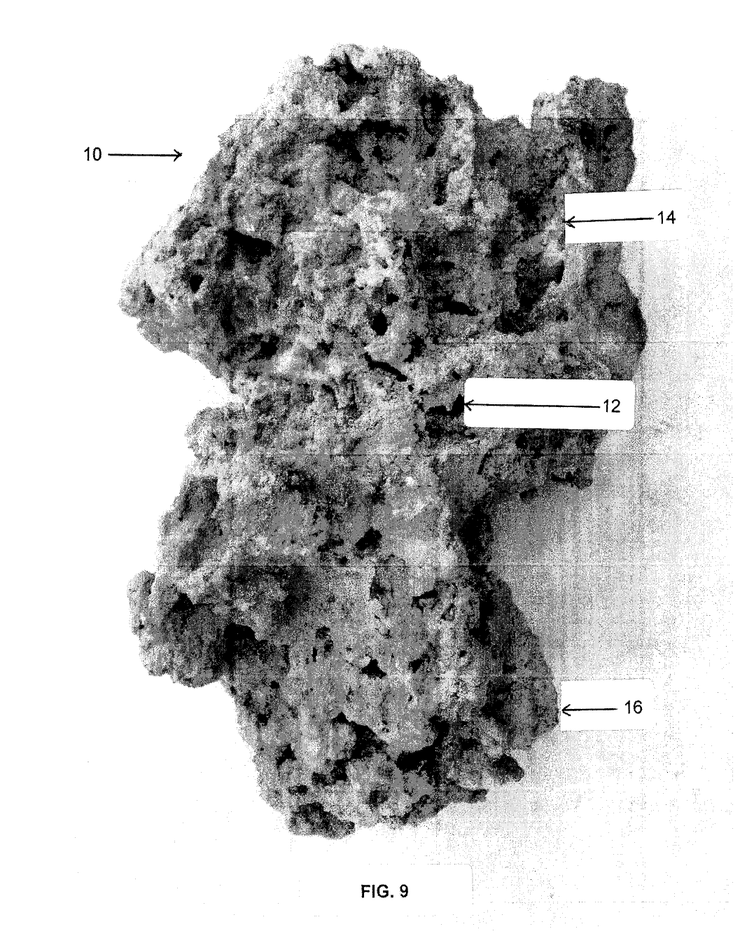

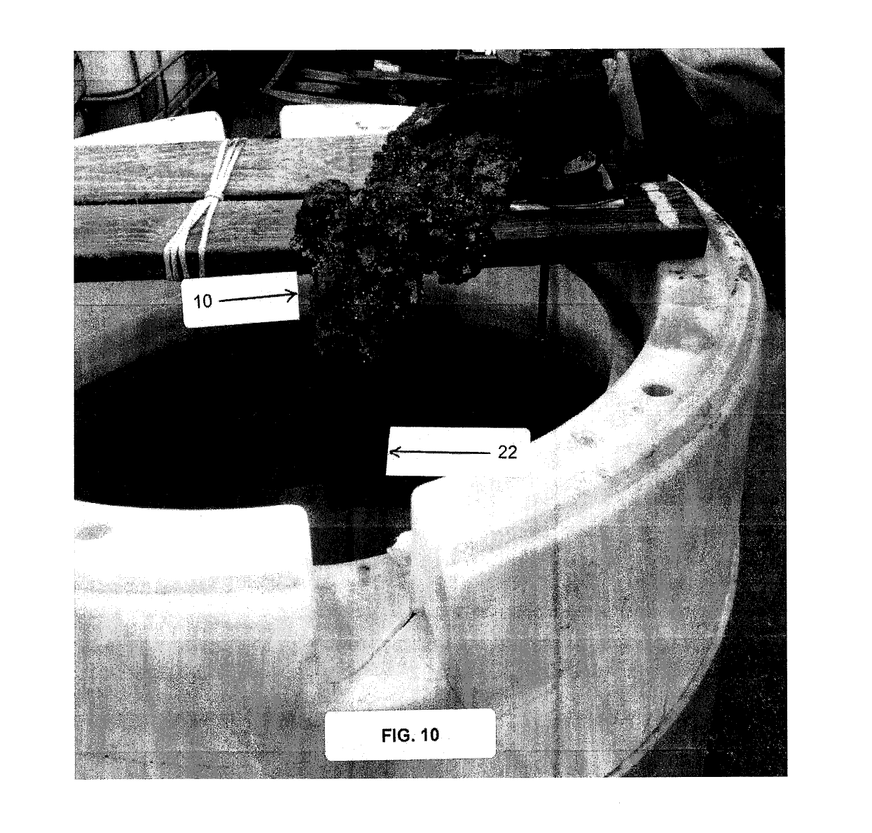

The method of manufacturing the preferred embodiment of a dormant bio-active rock includes: selecting or manufacturing a base rock as shown in FIGS. 1 and 8; coating the base rock with an aquarium safe coating to create a visually life-like background color as shown in FIGS. 2 and 9; coating the visually life-like base rock with a coloring to replicate the appearance of natural coralline algae as shown in FIGS. 3 and 4; submerging the visually life-like rock into a solution of commercially available dormant bacteria in a spored state or bacteria capable of remaining dormant when dried out as shown in FIGS. 5 and 10; and allowing the bacterial solution to dry.

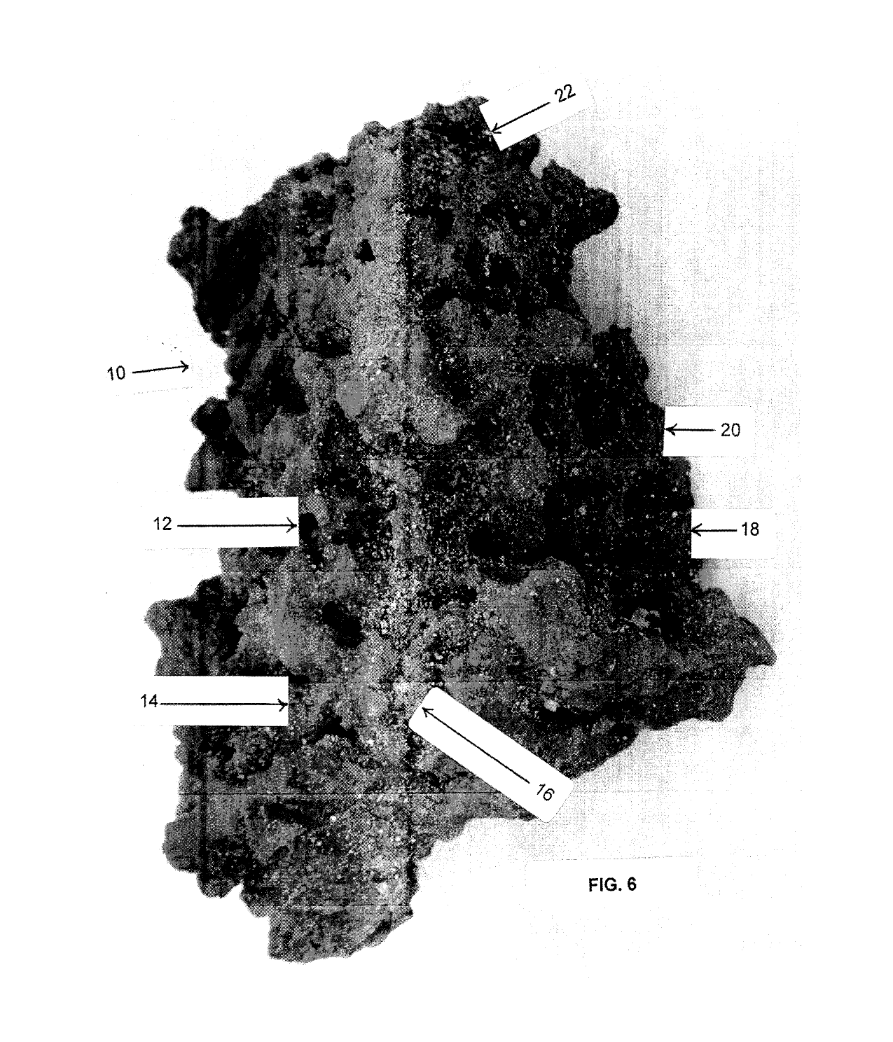

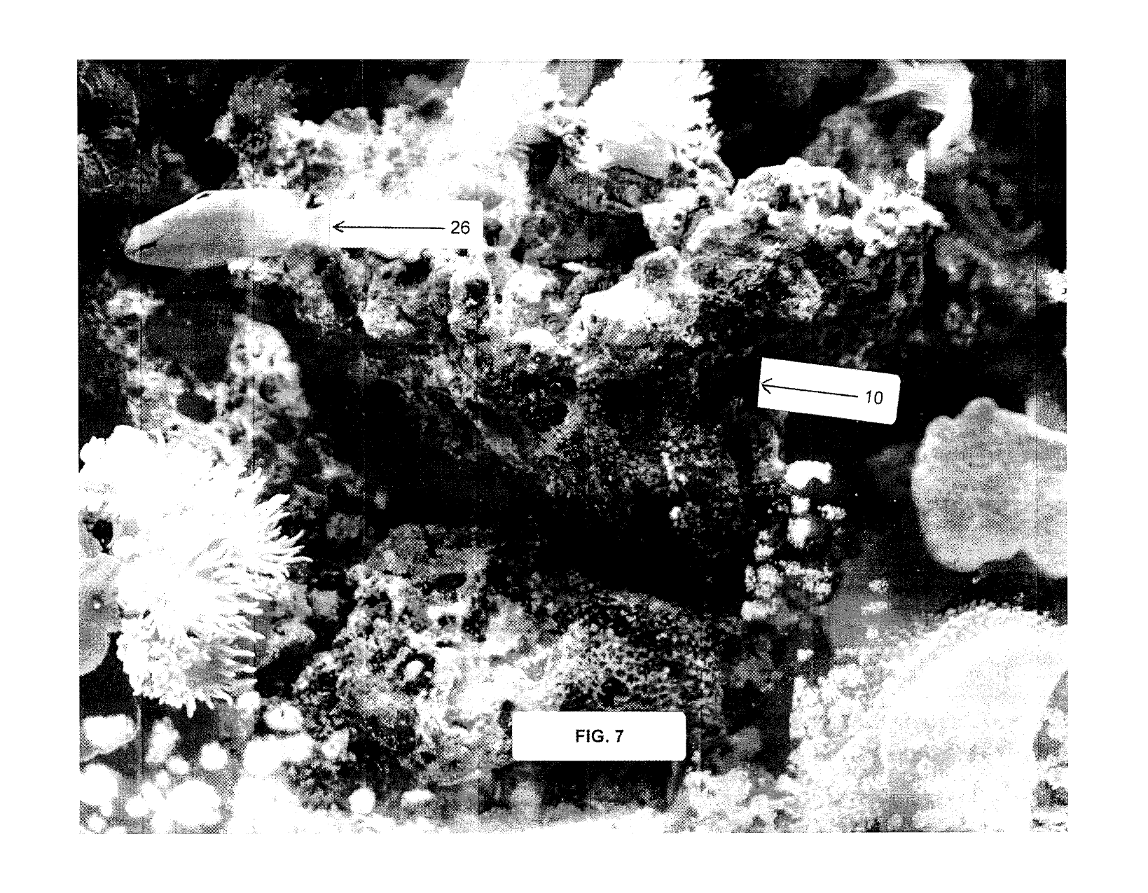

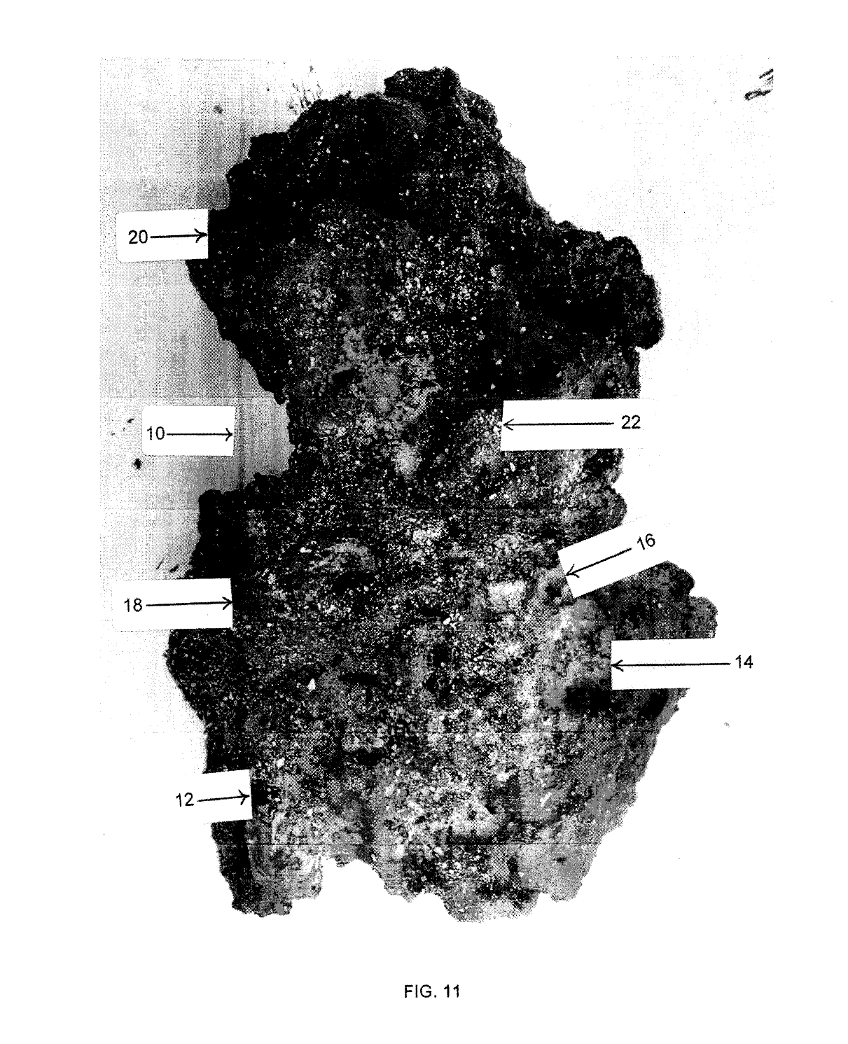

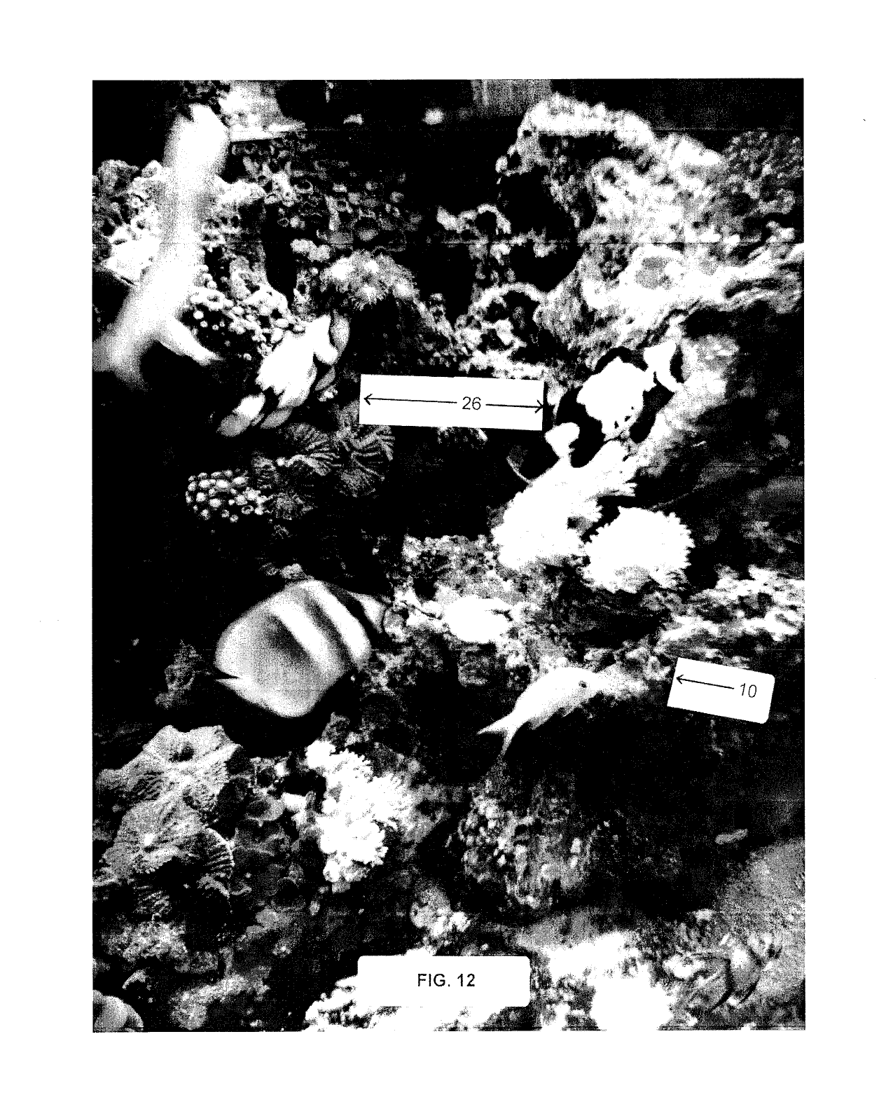

FIGS. 6 and 11 shows the preferred embodiment of the dormant bio-active rock ready to be packaged and shipped to a retail location, or immersed into an aquatic environment. FIGS. 7 and 12 show the bio-active rock operating in an aquatic environment, at which point the dormant bacteria has become active and is cycling the ammonia levels in the tank.

When selecting a base rock 10, the available surface area of the base rock 10 limits the quantity of biochemical cycling microorganisms that can attach. Therefore, it is preferable to select a rock that is irregularly shaped, porous 14, and with cavities 12 as shown in FIGS. 1 and 8. This maximizes the available surface area for deposit of dormant bacterial microorganisms. Natural porous rocks such as limestone, tufa and volcanic lava rock are good choices for a base rock 10 due to their porosity and roughness. Artificial base rocks 10 can be manufactured which embody these properties as well.

In the preferred embodiment aquarium safe coatings are used on the surface of the base rock 10 to color the base rock 10 to create the visual impression of colorful living organisms. Coatings can also be used to create various textures on the surface of the base rock 10. This is desirable as the base rock 10, when placed into an aquarium, will already look authentic and colorful FIGS. 7, 12 without waiting for living organisms to coat the rock in the aquarium (a process taking months) or having to transport living organisms on the surfaces of ocean collected or cultivated rocks at great risk of mortality and expense.

As seen in FIGS. 2 and 9, the base rock 10 can be coated with a natural background color 16 so that the appearance becomes that of a naturally occurring aquatic rock. The base rock 10 can then be colored with a first color coating 18 as shown in FIG. 3, and then a second color coating as shown in FIG. 4 which can create the appearance of natural coralline algae.

The base rock 10 can then be immersed of into a solution or suspension of either spored bacteria or a solution of bacteria that become dormant upon drying 22, as seen in FIGS. 5,10. This deposits the bacteria not only to the outer surfaces of the rock 10 but on the interior of the cavities 12 and pores as well. These types of bacteria are readily available as commercial preparations. If the base rock 10 is to be colored, it is preferable to color the base rock 10 to give it a visually life-like appearance prior to immersion into the substrate of either spored bacteria or bacteria that becomes dormant upon drying 22.

Allowing the rock 10 to dry deposits the bacteria from the substrate onto all the previously wetted internal and external surfaces, such as the cavities 12 and pores 14 of the rock 10, and allows the rock 10 to be packed in conventional packaging (such as cardboard boxes) and shipped by the most economical means.

The instant invention provides the desirable natural look and biochemical cycling function of a “live rock,” but in a more convenient and economical form than is presently available. A user can simply purchase the invention in a store from a dry goods section. These dry dormant bio-active rocks with an appealing life-like appearance, as show in FIGS. 6,11, may be placed into an aquarium FIGS. 7,12 where the bacteria become active and begins to function in their water purifying capacity within a matter of hours, thus preventing the aquatic life 26 from dying off. This is accomplished by the activation of the dormant bacteria with which the base rock 10 is inoculated. The dormant bacteria are activated by hydration and the presence of aquatic-life 26 waste upon which the bacteria feeds.

In the preferred embodiment, the first step is to procure a suitable terrestrial rock or manufacture a suitable rock as a base rock 10. Natural rock with preferred qualities includes limestone, tufa, or volcanic lava rock because of the high porosity and a rough exterior. Base rocks 10 may alternatively be manufactured utilizing various components such as gravels, shells, and cement. Recipes and instructions to manufacture this type of stone are readily available on the internet and in books.

Next, an aquarium safe coating to provide color, such as pure acrylic and epoxy paint, can be utilized to simulate the colorful coatings 16,18,20 of marine life found growing on rocks in the wild. Coralline algae are typically shades of dusty purple, green algae are shades of green and brown, and encrusting foraminifera such as Homotrema rubra are scarlet red. Many living sponges, tunicates, and other such encrusting organisms display a wide variety of colors. Although multiple colors add to the natural appearance and beauty it is not strictly necessary, and the dormant bio-active rock will operate the same even without coloring. The desired minimum result for a life-like appearance may be achieved with only a single color, but may include multiple colors. It is desirable (but not necessary) to either spray-coat or coat with a brush rather than dip the rock in color coating, as it produces a more natural and life-like appearance.

Once colored, it is preferable to allow the rock 10 to fully cure. This is achieved by allowing the now-colored base rock 10 to dry or cure completely, as some uncured coatings can be toxic to aquatic life. It is therefore prudent to consult with the coating manufacturer about curing times and methods when toxicity is a concern.

The bacterial inoculation is achieved by means of a tub, barrel, or other liquid bearing vessel filled with a solution or suspension of water purifying bacteria that are either in a spored state or are capable of dormancy when the liquid media has dried out 22. These bacteria are readily available from commercial sources such as aquaculture supply houses. The containment vessel must be of sufficient size to fully immerse the base rock 10 and thereby cause the bacteria solution 22 to fully penetrate the cavities 12 and pores 14 of the base rock 10. The solution or suspension 22 must them be allowed to dry completely without excessive heating. Once dry, the bacteria will be dormant and the bio-active rock is then ready to be shipped, stored, and eventually immersed into an aquatic environment.

Modifications to the invention can include admixtures to the coatings such as powders and sand to create more natural surface textures. Non-toxic putties may also be used to modify the surface textures by pressing into soft putty the surface features of an encrusting organism. The bacterial solution or suspension 22 may be more effective with the addition of a surfactant which facilitates the penetration of the solution into even the smallest micro-pores thereby increasing the bacterial population of the rock and improving the water purifying capacity of the invention.

The 3 classes of material components (i.e., the base rocks 10, surface coatings 16, 18, 20, and bacteria species in the solution 22) may be altered for economical or performance reasons. The sequence of manufacture can be altered as long as the surface coatings remain non-toxic, the bacteria remain viable, and it is dry enough for packaging and shipping.

Once the bacterial inoculation coating has dried, a manufacturer would be able to simply pack this invention as dry goods rather than livestock; in dry cardboards boxes and ship to a customer. If this customer is a distributor, the distributor simply stores it on a shelf until sold and shipped to a retailer who can also store it as dry goods, thereby saving valuable and expensive aquarium space. When an ultimate consumer buys the product to either add to an existing aquarium or begin a new aquarium, the customer can simply takes it home dry and place it into an aquarium. The dormant bio-active rock already looks life-like and visually appealing and introduction into the aquatic environment begins the process of purifying water within hours.

### Testing Description and Data

A total of nine tests were conducted to measure the rate at which the dormant bio-cycling rock of the present invention became active and began cycling ammonia levels in a tank. The goal of a dormant bio-cycling rock is to be able to quickly become active, because when a rock is introduced into a tank there will only be a matter of days before ammonia levels can reach levels dangerous to the aquatic life in the tank.

TEST 1

| | Day 1: | Day 2: | Day 3: | Day 4: |
|---|---|---|---|---|
| | May 19, 2014 | May 22, 2014 | May 27, 2014 | May 28, 2014 |
| Dormant | 1.5 ppm | 1.0 ppm | 0.25 ppm | 0.1 ppm |
| Bio- | | | | |
| Cycling | | | | |
| Rock | | | | |
| Base Rock | 1.5 ppm | 1.5 ppm | 1.5 ppm | 1.5 ppm |
| Control | 1.5 ppm | 1.5 ppm | 1.5 ppm | 1.5 ppm |
| (water) | | | | |

TEST 2

| | Day 1: | Day 2: | Day 3: | Day 4: |
|---|---|---|---|---|
| | Jun. 9, 2014 | Jun. 10, 2014 | Jun. 11, 2014 | Jun. 12, 2014 |
| Dormant | 2.0 ppm | 2.0 ppm | 1.5 ppm | 1.2 ppm |
| Bio-Cycling | | | | |
| Rock 1 | | | | |
| Dormant | 2.0 ppm | 2.0 ppm | 1.5 ppm | 1.2 ppm |
| Bio-Cycling | | | | |
| Rock 2 | | | | |
| Base Rock | 2.0 ppm | 2.0 ppm | 2.0 ppm | 1.5 ppm |
| Control | 2.0 ppm | 2.0 ppm | 2.0 ppm | 2.0 ppm |
| (water) | | | | |

TEST 3

| | Day 1: | Day 2: | Day 3: | Day 4: |
|---|---|---|---|---|
| | Jun. 23, 2014 | Jun. 24, 2014 | Jun. 25, 2014 | Jun. 26, 2014 |
| Dormant | 1.7 ppm | 1.7 ppm | 1.7 ppm | 0.8 ppm |
| Bio-Cycling | | | | |
| Rock 1 | | | | |
| Dormant | 1.7 ppm | 1.7 ppm | 1.5 ppm | 1.2 ppm |
| Bio-Cycling | | | | |
| Rock 2 | | | | |
| Base Rock | 1.7 ppm | 1.7 ppm | 1.7 ppm | 1.5 ppm |

TEST 4

| | Day 1: | Day 2: | Day 3: | Day 4: | Day 5: |
|---|---|---|---|---|---|
| | Sep. 9, 2014 | Sep. 10, 2014 | Sep. 11, 2014 | Sep. 12, 2014 | Sep. 13, 2014 |
| Dormant | 2.0 ppm | 2.0 ppm | 1.8 ppm | 1.2 ppm | 1.0 ppm |
| Bio-Cycling | | | | | |
| Rock 1 | | | | | |
| Dormant | 2.0 ppm | 2.0 ppm | 2.0 ppm | 1.8 ppm | 1.8 ppm |
| Bio-Cycling | | | | | |
| Rock 2 | | | | | |
| Base Rock | 2.0 ppm | 2.0 ppm | 2.0 ppm | 1.8 ppm | 1.8 ppm |
| Control | 2.0 ppm | 2.0 ppm | 2.0 ppm | 2.0 ppm | 2.0 ppm |
| (water) | | | | | |

TEST 5

| | Day 1: | Day 2: | Day 3: | Day 4: |
|---|---|---|---|---|
| | Sep. 25, 2014 | Sep. 26, 2014 | Sep. 27, 2014 | Sep. 28, 2014 |
| Dormant | 2.0 ppm | 2.0 ppm | 1.2 ppm | 1.2 ppm |
| Bio-Cycling | | | | |
| Rock 1 | | | | |
| Dormant | 2.0 ppm | 2.0 ppm | 1.2 ppm | 1.2 ppm |
| Bio-Cycling | | | | |
| Rock 2 | | | | |
| Control | 2.0 ppm | 2.0 ppm | 2.0 ppm | 2.0 ppm |
| (water) | | | | |
| Control | 2.0 ppm | 2.0 ppm | 2.0 ppm | 2.0 ppm |
| (water) | | | | |

TEST 6

| | Day 1: | Day 2: | Day 3: | Day 4: | Day 5: |
|---|---|---|---|---|---|
| | Jan. 12, 2015 | Jan. 13, 2015 | Jan. 14, 2015 | Jan. 15, 2015 | Jan. 16, 2015 |
| Dormant | 1.0 ppm | 1.0 ppm | Measurement | 0.5 ppm | 0.5 ppm |
| Bio-Cycling | | | missing | | |
| Rock | | | | | |
| Base Rock | 1.0 ppm | 1.0 ppm | 1.0 ppm | 1.0 ppm | 1.0 ppm |
| Control | 1.0 ppm | 1.0 ppm | 1.0 ppm | 1.0 ppm | 1.0 ppm |
| (water) | | | | | |

TEST 7

| | Day 1: | Day 2: | Day 3: | Day 4: |
|---|---|---|---|---|
| | Jan. 19, 2015 | Jan. 20, 2015 | Jan. 21, 2015 | Jan. 22, 2015 |
| Dormant | 1.5 ppm | 1.0 ppm | 1.0 ppm | 1.0 ppm |
| Bio-Cycling | | | | |
| Rock | | | | |
| Base Rock | 2.0 ppm | 2.0 ppm | 1.5 ppm | 1.5 ppm |
| Control | 2.0 ppm | 2.0 ppm | 2.0 ppm | 2.0 ppm |
| (water) | | | | |

TEST 8

| | Day 1: | Day 2: | Day 3: |
|---|---|---|---|
| | Jan. 22, 2015 | Jan. 23, 2015 | Jan. 24, 2015 |
| Dormant | 1.5 ppm | 1.5 ppm | 1.0 ppm |
| Bio-Cycling | | | |
| Rock 1 | | | |
| Dormant | 1.5 ppm | 1.5 ppm | 1.0 ppm |
| Bio-Cycling | | | |
| Rock 2 | | | |
| Control | 2.0 ppm | 1.5 ppm | 1.5 ppm |
| (water) | | | |
| Control | 2.0 ppm | 1.5 ppm | 1.5 ppm |
| (water) | | | |

TEST 9

| | Day 1: | Day 2: | Day 3: | Day 4: |
|---|---|---|---|---|
| | Jan. 28, 2015 | Jan. 29, 2015 | Jan. 30, 2015 | Feb. 2, 2015 |
| Dormant | 1.5 ppm | 1.5 ppm | 1.5 ppm | 1.0 ppm |
| Bio- | | | | |
| Cycling | | | | |
| Rock 1 | | | | |
| Dormant | 1.5 ppm | 1.5 ppm | 1.5 ppm | 1.0 ppm |
| Bio- | | | | |
| Cycling | | | | |
| Rock 2 | | | | |
| Control | 1.5 ppm | 1.5 ppm | 1.5 ppm | 1.5 ppm |
| (water) | | | | |
| Control | 1.5 ppm | 1.5 ppm | 1.5 ppm | 1.5 ppm |
| (water) | | | | |

In all the tests ammonium chloride was used to set ammonia levels. For testing purposes, the ammonia levels were set to levels dangerous to aquatic life, and then either nothing (control group), a base rock without the coating of dormant bacterial substrate, or a dormant bio-active rock were introduced into the environment. Ammonia levels were measured with a titration kit in parts per million (ppm) to measure the activity in the biochemical cycling process.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A dormant biochemically active rock for an aquarium comprising:
a base rock having an outer surface; and
a bacterial coating, said bacterial coating covering said outer surface of said base rock.

2. The dormant biochemically active rock of claim 1 wherein said bacterial coating contains bacteria either in a spored state or bacteria capable of dormancy when the liquid media has dried out, and which become biochemically active after immersion in water.

3. The dormant biochemically active rock of claim 1 wherein said base rock is a porous rock.

4. The dormant biochemically active rock of claim 3 wherein said bacterial coating covers said surface area of said base rock and fills the pores of said base rock.

5. The dormant biochemically active rock of claim 4 wherein said bacterial coating contains bacteria either in a spored state or bacteria capable of dormancy when the liquid media has dried out, and which become biochemically active after immersion in water.

6. The dormant biochemically active rock of claim 5 wherein said visually life-like rock can be stored at room temperature prior to immersion, without mortality to said bacteria.

7. The dormant biochemically active rock of claim 1 further comprising a color coating on said porous rock.

8. A method for making a dormant biochemically active rock for an aquarium comprising the steps of:
Selecting a base rock;
Coating said base rock with a bacterial coating; and
Drying said bacterial coating.

9. The method for making the dormant biochemically active rock for an aquarium of claim 10 further comprising the step of coating said base rock with an aquarium safe color coating.

10. The method for making the dormant biochemically active rock for an aquarium of claim 11 further comprising the step of curing said aquarium safe color coating.
